(19) United States
(12) Patent Application Publication
(10) Pub. No.: US 2014/0017954 A1
(43) Pub. Date: Jan. 16, 2014

(54) AUDIO JACK CONNECTOR FACILITATING INSERTION OF A CONTACT INTO INSULATIVE HOUSING

(71) Applicant: Wei-De Zhang, Shenzhen (CN)

(72) Inventor: Wei-De Zhang, Shenzhen (CN)

(21) Appl. No.: 13/687,817

(22) Filed: Nov. 28, 2012

(30) Foreign Application Priority Data
Jul. 12, 2012 (CN) 201220335799.6

(51) Int. Cl. H01R 24/58

(52) U.S. Cl. CPC H01R 24/58
USPC 439/668

(57) ABSTRACT

An audio jack connector includes an insulative housing (2) defining a slippery surface (22) and an electrical contact (33). The electrical contact includes a planar main portion (331), a front arc portion (334) unitarily extending from the main portion initially upwardly and further toward a rear end of the main portion, and an elastic portion (332) unitarily extending rearwardly from the front arc portion and spaced from the main portion. Said elastic portion including a flexible beam (3321) linked to the front arc portion and a rear arc portion (3320) which is linked to the flexible beam and essentially extends above the flexible beam for contacting with a plug. The rear arc portion defines at least one cut portion (3325) guided by the slippery surface when the electrical contact is inserted in the insulative housing.

### CROSS-REFERENCE TO RELATED APPLICATIONS

This application is a Continuation-in-part Application of U.S. patent application Ser. No. 13/413,860 filed on Mar. 7, 2012 and entitled “AUDIO JACK CONNECTOR HAVING LOW INSERTION FORCE AND HIGH EJECTION FORCE”, which has the same applicant and assignee as the present invention.

### BACKGROUND OF THE INVENTION

1. Field of the Invention

The present invention relates generally to an audio jack connector, and more particularly to an audio jack connector having low insertion force and high ejection force.

2. Description of Related Arts

An audio jack connector is usually arranged on an electronic device and an audio plug connector is inserted into the audio jack connector for signal transmission. A user expects low insertion force for facilitating insertion of the audio plug connector. Additionally, high ejection force is expected because the audio jack connector is arranged on peripheral of the electronic device and the audio plug connector may be inadvertently withdrawn from the audio jack connector.

U.S. Patent Pub. No. 2012/0231679 discloses an electrical contact of an audio jack connector with low insertion force when an audio plug connector is inserted but with high ejection force when the audio plug connector is withdrawn. The electrical contact includes a main portion, a soldering portion bending from a lateral edge of the main portion, an elastic portion extending curvedly from a distal end of the main portion to be located above the main portion. The elastic portion has a flexible beam, a first arm extending upwardly from the flexible beam and a second arm curvedly bending from the first arm. The first arm is consistent with a first direction along which an audio plug connector is inserted. The second arm is adverse to a second direction along which the audio plug connector is withdrawn. Therefore, deformation of the elastic portion is compliant with the first direction along which the audio plug connector is inserted, the electrical contact of the present invention provides a low insertion force; and deformation of the elastic portion is conversed to the second direction along which the audio plug connector is withdrawn, a high ejection force is provided to meet the user's expectation. However, such electrical contact has a small size such that it is difficult for assembling the electrical contact in an insulative housing of the audio jack connector.

Hence, an audio jack connector which facilitates insertion of an electrical contact in the insulative housing is desired.

### SUMMARY OF THE INVENTION

Accordingly, an object of the present invention is to provide an audio jack connector which facilitates insertion of an electrical contact in the insulative housing.

To achieve the above object, an audio jack connector includes an insulative housing defining a slippery surface and an electrical contact. The electrical contact includes a planar main portion, a front arc portion unitarily extending from the main portion initially upwardly and further toward a rear end of the main portion, and an elastic portion unitarily extending rearwardly from the front arc portion and spaced from the main portion. Said elastic portion including a flexible beam linked to the front arc portion and a rear arc portion which is linked to the flexible beam and essentially extends above the flexible beam for contacting with a plug. The rear arc portion defines at least one cut portion guided by the slippery surface when the electrical contact is inserted in the insulative housing.

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of an audio jack connector in a preferred embodiment of the present invention;

FIG. 2 is a perspective, exploded view of the audio jack connector;

FIG. 3 is similar to but taken a different view from FIG. 1;

FIG. 4 is a perspective view of the electrical contact; and

FIG. 5 is a right side elevational view of the electrical contact.

### DETAILED DESCRIPTION OF THE PREFERRED EMBODIMENT

Reference will now be made in detail to the preferred embodiment of the present invention.

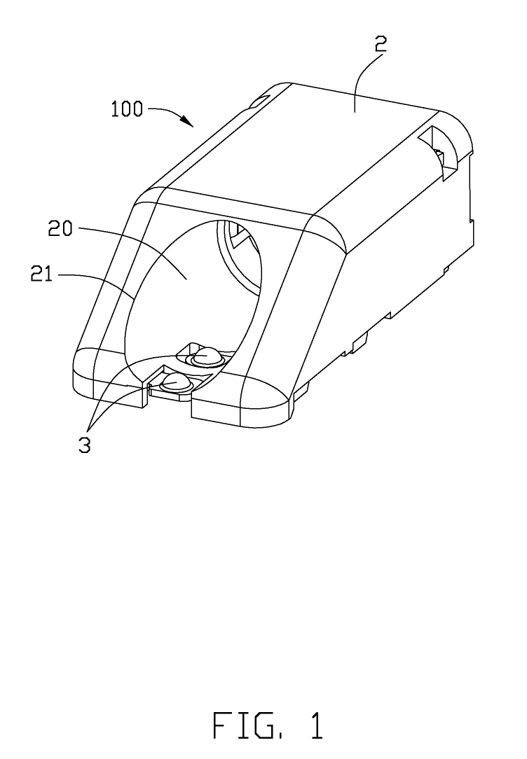

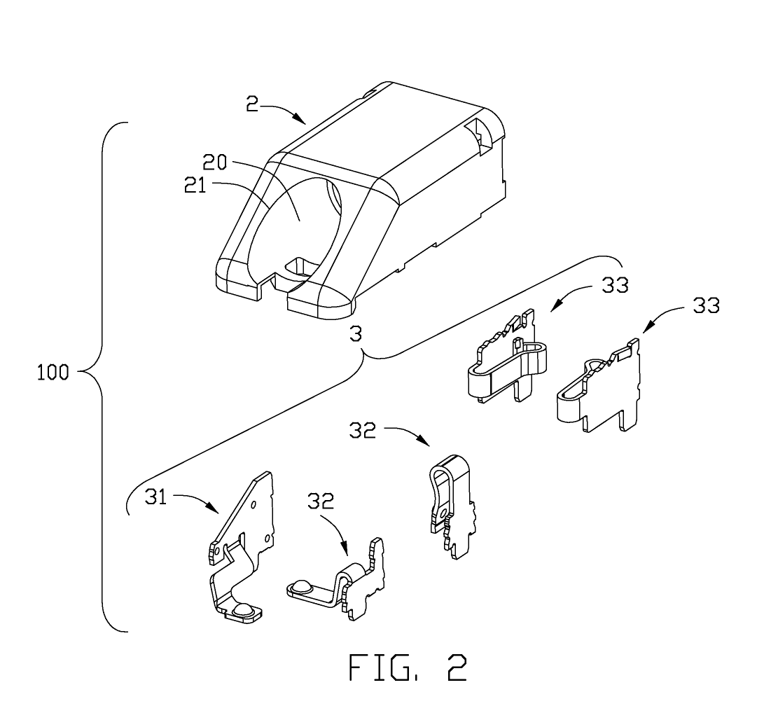

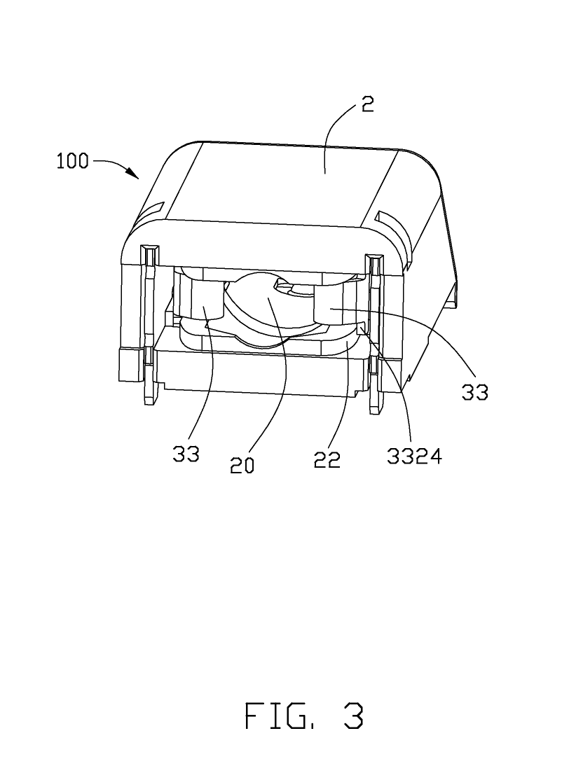

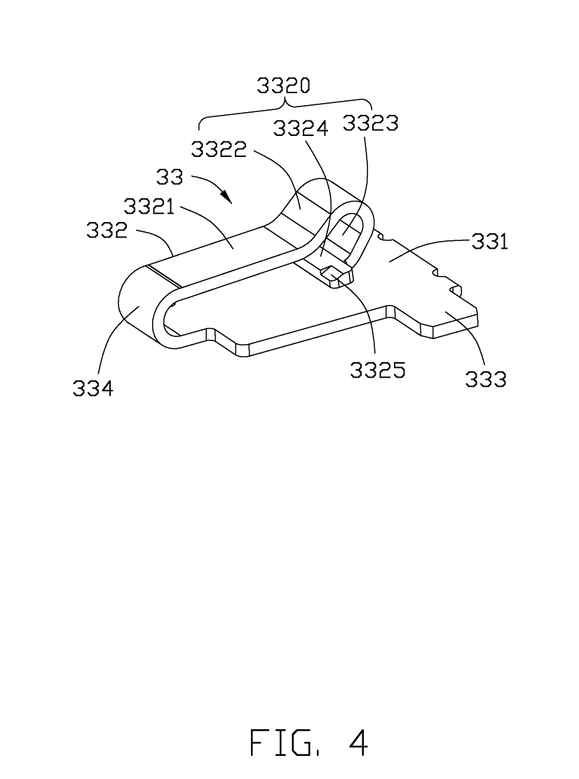

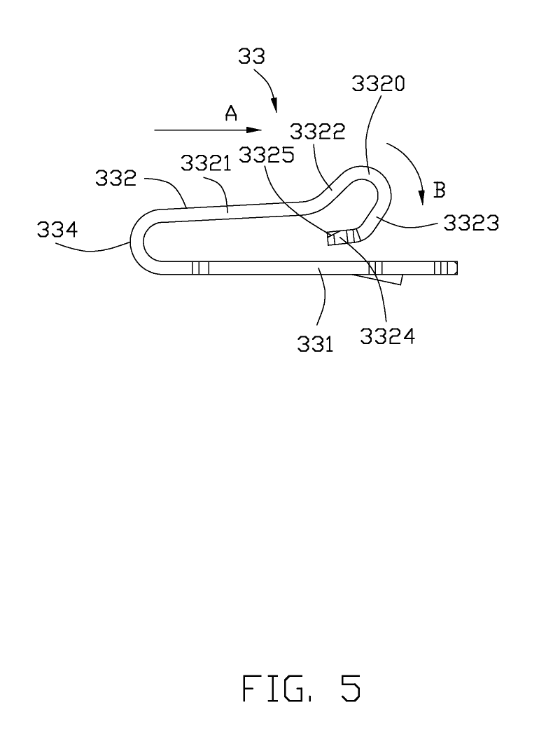

Referring to FIGS. 1 to 5, an audio jack connector 100 comprises an insulative housing 2 and a plurality of contacts 3 retained in the insulative housing 2. The insulative housing 2 defines a receiving space 20 for receiving an audio plug connector (not shown) and an insertion opening 21 communicating with the receiving space 20 for guiding the audio plug. The insulative housing 2 defines a slippery surface 22 taken a rear view as shown in FIG. 3. The contacts 3 comprise a grounding contact 31, a pair of signal contacts 32, and a pair of electrical contacts 33. Each electrical contact 33 comprises a planar main portion 331 retained to the insulative housing 2, a front arc portion 334 unitarily extending from a front end of the main portion 331 initially upwardly and further toward a rear end of the main portion 331, and an elastic portion 332 unitarily extending rearwardly from the front arc portion 334 and spaced from the main portion 331. Said elastic portion 332 includes a flexible beam 3321 linked to the front arc portion 334 and a rear arc portion 3320 which is linked to the flexible beam 3321. The flexible beam 3321 is essentially parallel to the main portion 331. The rear arc portion 3320 essentially extends above the flexible beam 3321 for contacting with the audio plug connector and adapted to abut against the main portion 331 when the elastic portion 332 is deflected toward the main portion 331. The front arc portion 334 extends around 180 degrees to define rearward facing opening while the rear arc portion 3320 extends around 270 degrees to define a forwardly and downward facing opening. The front arc portion 334 and the rear arc portion 3320 are spaced from each other via the flexible beam 3321 with a distance which is two times over a dimension of either the front arc portion 334 and the rear arc portion 3320 along a front-to-back direction. The rear arc portion 3320 essentially extends initially rearwardly and upwardly and successively downwardly and further forwardly to define wholly a loop like configuration regardless of whether a forward opening remains around a free end of the rear arc portion 3320 or not. The rear arc portion 3320 includes a first arm 3322 with an outer surface facing forwardly and upwardly, and a second arm 3323 with another outer surface facing rearwardly. A block portion 3324 is located at a free end of the rear arc portion 3320, extending along a transverse direction with respect to the rear arc portion 3320. A pair of cut portions 3325 is defined on two sides of the block portion 3324. The cut portions 3325 are guided by the slippery surfaces 22 when the electrical contact 33 is inserted in the insulative housing 2 for facilitating assembling the electrical contacts 33. A solder portion 333 is formed on a side region of the main portion 331. The solder portion 333 is located behind the rear arc portion 3320 in a front-to-back direction.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An audio jack connector comprising:
an insulative housing defining a slippery surface; and
an electrical contact comprising:
a planar main portion retained to the insulative housing;
a front arc portion unitarily extending from a front end of the main portion initially upwardly and further toward a rear end of the main portion; and
an elastic portion unitarily extending rearwardly from the front arc portion and spaced from the main portion, said elastic portion including a flexible beam linked to the front arc portion and a rear arc portion which is linked to the flexible beam and essentially extends above the flexible beam for contacting with a plug and adapted to abut against the main portion when the elastic portion is deflected toward the main portion; wherein
the front arc portion extends around 180 degrees to define rearward facing opening while the rear arc portion extends around 270 degrees to define a forwardly and downward facing opening; wherein
the rear arc portion defines at least one cut portion guided by the slippery surface when the electrical contact is inserted in the insulative housing.

2. The audio jack connector as claimed in claim 1, wherein the front arc portion and the rear arc portion are spaced from each other via the flexible beam with a distance which is two times over a dimension of either the front arc portion and the rear arc portion along a front-to-back direction.

3. The audio jack connector as claimed in claim 1, wherein a block portion is located at a free end of the rear arc portion and extends along a transverse direction with respect to the rear arc portion, and wherein the at least one cut portion is defined on two sides of the block portion.

4. The audio jack connector as claimed in claim 1, wherein the flexible beam is essentially parallel to the main portion.

5. The audio jack connector as claimed in claim 1, wherein a solder portion is formed on a side region of the main portion.

6. The audio jack connector as claimed in claim 5, wherein the solder portion is located behind the rear arc portion in a front-to-back direction.

7. The audio jack connector as claimed in claim 1, wherein the rear arc portion includes a first arm with an outer surface facing forwardly and upwardly, and a second arm with another outer surface facing rearwardly.

8. An audio jack connector comprising:
an insulative housing defining a slippery surface; and
an electrical contact comprising:
a planar main portion retained to the insulative housing;
a front arc portion unitarily extending from a front end of the main portion initially upwardly and further toward a rear end of the main portion; and
an elastic portion unitarily extending rearwardly from the front arc portion and spaced from the main portion, said elastic portion including a flexible beam linked to the front arc portion, and a rear arc portion which is linked to the flexible beam and essentially extends above the flexible beam for contacting with a plug and adapted to abut against the main portion when the elastic portion is deflected toward the main portion; wherein
the rear arc portion essentially extends initially rearwardly and upwardly and successively downwardly and further forwardly to define wholly a loop like configuration regardless of whether a forward opening remains around a free end of the rear arc portion or not; wherein
the front arc portion and the rear arc portion are spaced from each other via the flexible beam with a distance which is more than two times of a dimension of either the front arc portion and the rear arc portion in a front-to-back direction; wherein
the rear arc portion defines at least one cut portion guided by the slippery surface when the electrical contact is inserted in the insulative housing.

9. The audio jack connector as claimed in claim 8, wherein the flexible beam is essentially parallel to the main portion.

10. The audio jack connector as claimed in claim 8, wherein a block portion is located at a free end of the rear arc portion and extends along a transverse direction with respect to the contact section, and wherein the at least one cut portion is defined on two sides of the block portion.

11. An audio jack connector comprising:
an insulative housing defining a mating cavity in a front portion and a slippery surface on a rear portion in a front-to-back direction;
a contact receiving passageway formed in the housing beside said mating cavity in a transverse direction perpendicular to said front-to-back direction;
a contact disposed in the contact receiving passageway, said contact defining a planar main body with a retention structure thereon to retain the contact in the housing, a front U-shaped structure located on a front end of the main body, a rear U-shaped structure located around a rear side of the housing and by an outer side of the main body in the transverse direction, and a flexible beam connected between the front U-shaped structure and the rear U-shaped structure, a blocking portion located at a free end of the rear U-shaped structure and equipped with a cutout structure for compliantly guidably moving along the slippery surface for preloading during assembling the contact into the housing from the rear side of the hosing forwardly; wherein
the front U-shaped structure is open to the rear side of the housing and the rear U-shaped structure is open toward the main body in an oblique manner and extends into the mating cavity, while both the flexible beam and the blocking portion extend roughly parallel to the main body under condition that the blocking portion is closer to the main body than the flexible beam in said transverse direction.

12. The audio jack connector as claimed in claim 11, wherein the rear U-shaped structure is open obliquely and forwardly.

13. The audio jack connector as claimed in claim 11, wherein said cutout is located offset from the rear U-shaped structure in a vertical direction perpendicular to said front-to-back direction and said transverse direction.
